(19) United States
(12) Patent Application Publication
(10) Pub. No.: US 2017/0178099 A1
(43) Pub. Date: Jun. 22, 2017

(54) POINT OF SALE DEVICE

(71) Applicant: HEWLETT-PACKARD DEVELOPMENT COMPANY, L.P., HOUSTON, TX (US)

(72) Inventors: Binh T. TRUONG, HOUSTON, TX (US); Manny NOVOA, HOUSTON, TX (US); Michael Dai-Duong NGUYEN, HOUSTON, TX (US)

(21) Appl. No.: 15/325,751

(22) PCT Filed: Jul. 29, 2014
(86) PCT No.: PCT/US2014/048579

§ 371 Date: Jan. 12, 2017

(51) Int. Cl. G06Q 20/20; G06F 9/44; H04W 92/18; G06Q 20/32; G06Q 30/06

(52) U.S. Cl. CPC G06Q 20/201; G06Q 20/204; G06Q 20/209; G06Q 20/322; G06Q 30/06; G06Q 20/202; H04W 92/18; G06F 9/4413; G06Q 20/20

(57) ABSTRACT

The present disclosure provides methods and systems for implementing plug and play (PnP) support for a peripheral point of sale (POS) device. In an example of a method, a PnP control interface is installed above a universal point of sale (UPOS) software interface. A disconnection of a peripheral POS device is detected and a UPOS software state for the peripheral POS device is stored. The PnP control interface is used to perform finalization method on a list of active peripheral POS devices in a Logical Device Name (LDN) library and an outstanding process for the peripheral POS device is terminated.

### BACKGROUND

Plug-and-Play (PnP) is a set of standards that allow for automatic detection and minor configuration of computer devices without user intervention. Point of sale (POS), Object Linking and Embedding for Retail POS (OPOS), and universal point of sale (UPOS) are industry standards for retail and vending technologies used around the world.

### BRIEF DESCRIPTION OF THE DRAWINGS

Certain examples are described in the following detailed description and in reference to the drawings, in which:

FIG. 1A is an example block diagram of a computer device for implementing PnP support for a peripheral POS device in accordance with the principles disclosed herein;

FIG. 1B is a more detailed example of the computer device;

FIG. 2 illustrates an example computer system to implement PnP support for a mobile computer device at an expansion dock;

FIG. 3 is an process flow diagram of an example method for implementing PnP support for the removal of a peripheral POS device;

FIG. 4 is a process flow diagram of an example method for implementing PnP support for the connection of a peripheral POS device; and

FIG. 5 is an example block diagram showing a non-transitory, computer-readable media that holds code that enables the PnP support for a peripheral POS device.

### DETAILED DESCRIPTION OF SPECIFIC EXAMPLES

The Universal Point of Sale (UPOS) standard protocol lacks native Plug-and-Play (PnP) support for peripheral devices. Further, most serial peripherals, often used in point of sale equipment, do not support hot docking, or device insertion and removal while energized. For instance, a serial, or RS232, attached device may hang as a result of a disconnect event or reconnect event, and there is no provision on the serial “bus” to reset that peripheral. Additionally, most legacy UPOS drivers will encounter disconnect and reconnect issues. For instance, many Universal Serial Bus (USB) peripheral devices that utilize virtual, a USB to Serial protocol do not support OS generated PnP events at the control layer. Further, some USB human interface device (HID) drivers lack support for device or power removal required to support hot docking for mobile POS devices.

In various examples described herein, support for a PnP functionality is used to support the disconnecting and reconnecting of a peripheral POS device, for example, to allow the docking and undocking of a computer sales device. A PnP control interface may be added to an operating system stack above a UPOS software interface. As used herein, an operating system stack is a sequence of code modules that start at a device interface level, and proceed to an application program level. The code modules are designed to communicate information between the application program level and a POS peripheral device. For example, an entered price for an item may be translated to a command sequence to be sent to a serial receipt printer. In another example, a barcode scanner may translate the lines of a barcode to a binary sequence that is sent to a POS terminal through a serial interface. The binary sequence is received, translated into a numeric value, and provided to an application program by the stack. The application program can then act on the numeric value, for example, looking up a corresponding item and price. Generally, as described, disconnecting or undocking a peripheral POS device will cause the operation of the device, the POS terminal, or both, to fail. This is especially likely if the device is serially connected to the POS terminal, even through a USB to serial convertor. In an example described herein, the PnP control interface detects the loss of communications and saves the current operational state of the UPOS software interface, including any operations that are in progress. The PnP control interface may then perform finalization methods to a list of active peripheral POS devices in a Logical Device Name (LDN) library, for example, removing the name of the disconnected device. Any outstanding processes related to the peripheral POS device that has been disconnected may be terminated.

If the peripheral POS device is reconnected, for example, by being placed in a docking station, the PnP control interface detects that the communications have been reestablished. The PnP control interface can then perform initialization methods to the list of active peripheral POS devices in the LDN library, for example, adding the name of the operational unit back in to the library. The PnP control interface can then restore the state of the UPOS software interface to the state prior to the disconnection, and restart any jobs that were in progress at the time of the disconnect.

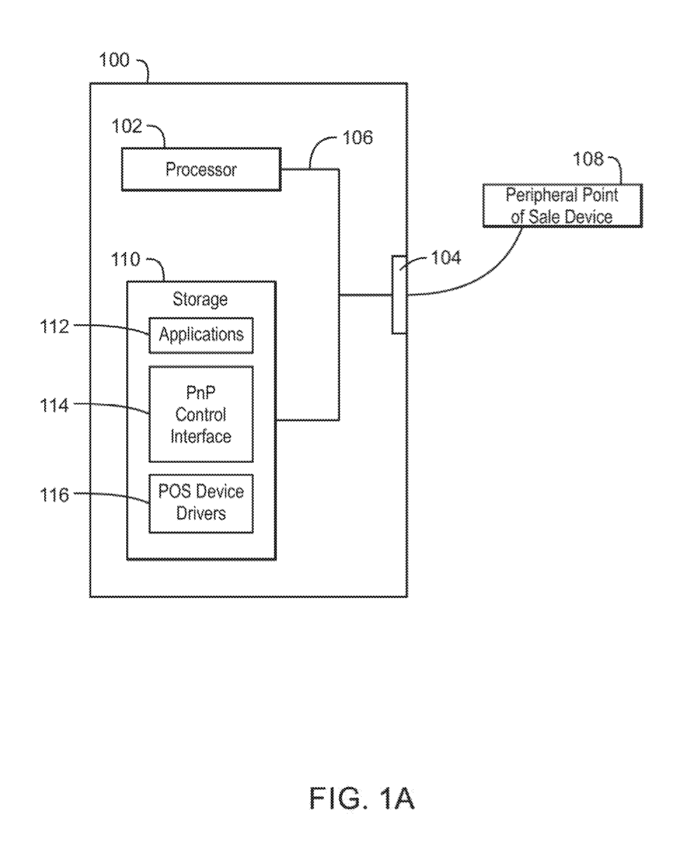

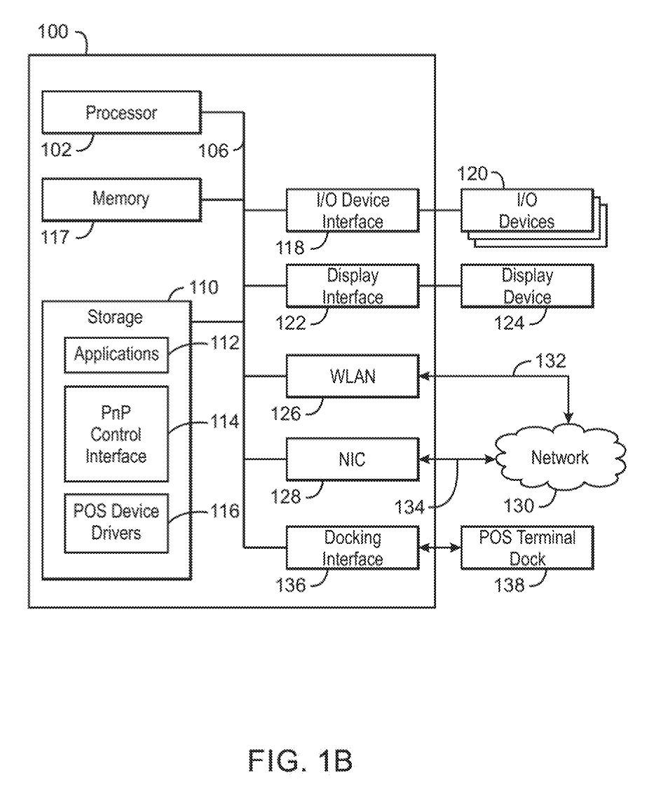

FIG. 1A is an example block diagram of a computer device 100 for implementing PnP support for a peripheral POS device in accordance with the principles disclosed herein. The computer device 100 may be, for example, a POS terminal, a portable peripheral POS device, an active expansion dock, a computing tablet, a laptop computer, or a desktop computer, among others. The computer device 100 may include a processor 102 to execute stored instructions. The processor 102 can be a single core processor, a dual-core processor, a multi-core processor, a computing cluster, or the like. A peripheral interface 104 may be coupled to the processor 102 through a bus 106. The bus 106 may be a communication system that transfers data between various components of the computer device 100. In examples, the bus 106 may be a PCI, ISA, PCI-Express. HyperTransport®, NuBus, or the like. The peripheral interface 104 may be a USB port, a serial port, a parallel port, an Ethernet port, or any number of other communication ports. A peripheral point of sale device 108, such as a portable sales terminal, a printer, a credit card reader, a bar code scanner, and the like, may be connected to the computer device 100 through the peripheral interface 104.

The computer device 100 may also include a storage device 110. The storage device 110 may include non-volatile storage devices, such as a solid-state drive, a hard drive, an optical drive, a flash drive, an array of drives, or any combinations thereof. In some examples, the storage device 110 may provide operating memory for the processor, as well as longer term storage of code modules. The storage device 110 may include a number of applications 112 to provide the computer device 100 with POS functionality. For example, the applications 112 can include POS applications, UPOS applications, and OPOS applications used in transactions between retailers and consumers when buying and selling goods and services. The point of sale applications can include features to implement various POS functionality, such as inventory management, customer relationship management (CRM), financials, and warehousing, for example,

The storage device 110 may include a PnP control interface 114 as a control interface layer for PnP devices, including peripheral POS devices, to implement the techniques described herein. For example, the PnP control interface 114 may operate as a control layer below the UPOS software layer of applications 112 to provide hot plug functionality. As used herein, hot plug functionality allows the disconnection and reconnection of devices without requiring reconfiguration, rebooting, or both. Further, the terms “above” and “below” indicate an order that data reaches a software module. The application layer is generally at the highest level. Layers below the application layer are used to translate data from the application into formats that are compatible with other devices, and the lowest level of the software can be a device driver used to place data on a physical interface. The software levels, however, are not limited to these placements, as a software layer, may intercept data and commands intended for other layers.

The PnP control interface 114 allows existing peripheral devices to be used without development and requalification effort. Further, existing PUS device drivers can be used without needing to be replaced. As used herein, existing UPOS device drivers are not PnP aware, e.g., do not detect, or respond to newly connected devices. UPOS device drivers 116 are also stored in the storage device 110. The PnP control interface 114 may be layered between the UPOS device drivers 116 and UPOS application software 112.

The computer device 100 is not necessarily limited to the devices shown in FIG. 1A. In some examples, additional units may be added to provide functionality, as shown in FIG. 1B.

FIG. 1B is a more detailed example of the computer device 100. For example, a separate memory device 117 may be used to store instructions that are executable by the processor 102 to implement the techniques described herein. The memory device 104 can include random access memory (RAM), e.g., SRAM, DRAM, zero capacitor RAM, eDRAM, EDO RAM, DDR RAM, RRAM, PRAM, read only memory (ROM), e.g., Mask ROM, PROM, EPROM, EEPROM, flash memory, or any other suitable memory systems.

The processor 102 may be connected through the bus 106 to an input/output (I/O) device interface 118 to connect the computer device 100 to one or more I/O devices 120. The I/O devices 120 may include, for example, a keyboard, a mouse, or a pointing device, wherein the pointing device may include a touchpad or a touchscreen, among others. In some examples, the I/O devices 120 may built-in components of the computer device 100. In some examples, the I/O devices 120 are located externally to the computer device 100. The I/O devices 120 may also include peripheral POS devices, such as peripheral point of sale device 108. In these examples, the I/O device interface 118 may include a serial port, or other serial device interface, such as a USB port, or the other interfaces listed with respect to peripheral interface 104.

The POS platform in retail industries uses a number of hardware devices and software applications depending on individual needs and requirements. Peripheral POS devices can include but are not limited to barcode scanners, radio frequency identification (RFID) devices, POS touchscreen devices, magnetic stripe readers, electronic funds transfer (EFT) modems, digital weighing scales, POS receipt printers, line displays, and cash drawers. A POS terminal, such as a smart electronic cash register, can provide core operational functionality. Some of the example POS applications and peripheral POS devices can be implemented by the computer device 100, while some POS applications and peripheral POS devices can be implemented through or as a particular I/O device 120.

The processor 102 may also be linked through the bus 106 to a display interface 122 to connect the computer device 100 to display devices 124. A display device 124 may be a built-in component of the computer device 100, or connected externally to the computer device 100. The display device 124 may also include a display screen of a smartphone, a computing tablet, a computer monitor, a television, or a projector, among others. In some examples, the display screen may include a touch screen component, for example, a touch-sensitive display. The touch screen component may allow a user to interact directly with the display screen of the display device 124 by touching the display screen with a pointing device, one or more fingers, or a combination of both.

A wireless local area network (WLAN) 126 and a network interface controller (NIC) 128 may also be linked to the processor 102. The WLAN 126 may link the computer device 100 to a network 130 through a radio signal 132. Similarly, the NIC 128 may link the computer device 100 to the network 130 through a physical connection, such as a cable 134. Either network connection 126 or 128 allows the computer device 100 to network with resources, such as the Internet, printers, fax machines, email, instant messaging applications, and with files located on storage servers.

A docking interlace 136 may be used to couple the computer device 100 to a dock, such as a POS terminal dock 138. When placed in the POS terminal dock 138, the computer device 100 may reestablish connections to other peripheral devices, such as printers, modems, keypads, and the like, as described herein. While in the POS terminal dock 138, the computer device 100 may provide the user interface functions. In some implementations, the computer device 136 becomes an attached peripheral device when in the POS terminal dock 138, for example, downloading current purchase information to the POS terminal for completion of a purchase.

The block diagrams of FIGS. 1A and 1B are not intended to indicate that the computer device 100 is to include all of the components shown in FIGS. 1A and 1B. Any number of additional components may be included within the computer device 100, depending on the details of hot-plug control and specific implementation of PnP functionality for POS. devices described herein. For example, the items discussed are not limited to the functionalities mentioned, but the functions could be done in different places, or by, different devices, if at all.

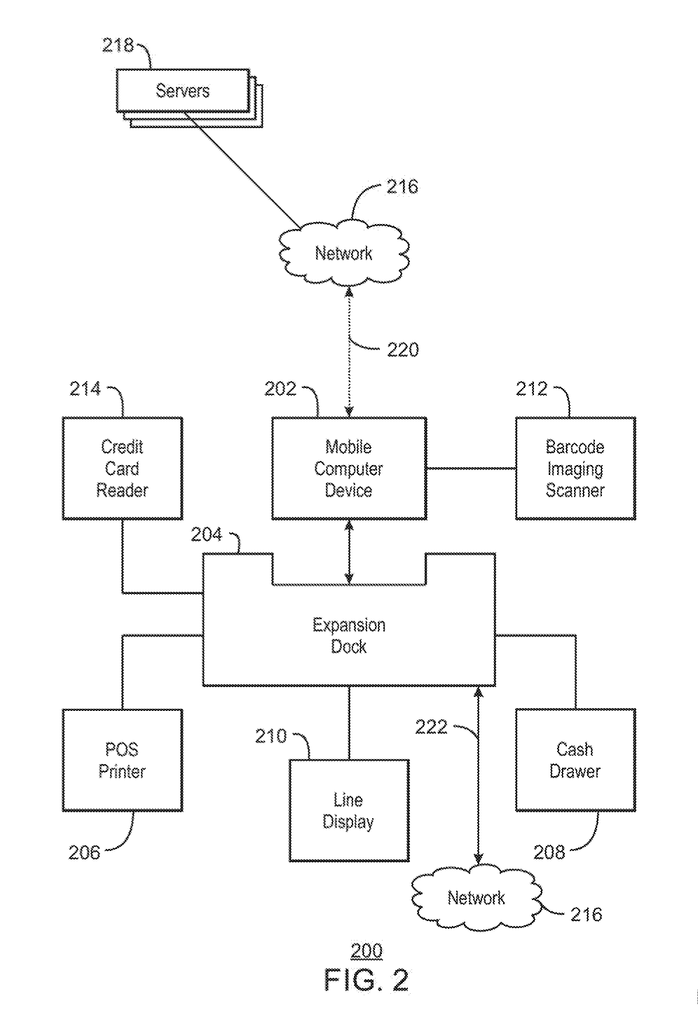

FIG. 2 illustrates an example computer system 200 to implement PnP support for a mobile computer device 202 at an expansion dock 204. In some examples, the mobile computer device 202 may be as described with respect to FIG. 1. The expansion dock 204 may connect with mobile computer device 202 and provide access to various peripheral POS devices. The peripheral POS devices can include POS printer 206 to print receipts for transactions with customers. The peripheral POS devices connected to the mobile computer device 202 through the expansion dock 204 can include a cash drawer 208. A line display 210 can also be connected to the expansion dock 204. In some examples, the expansion dock 204 may part of a POS terminal that provides complete POS functionality, for example, using the mobile computer device 204 as a detachable peripheral. In these examples, the POS terminal may be usable when the mobile computer device 202 is removed by a salesperson, for example, by other salespersons.

In some examples, a barcode imaging scanner 212 is connected to, or incorporated into, the mobile computer device 202. The barcode imaging scanner 212 may be used to read Universal Product Code (UPC) barcodes, or similar identification symbols tagged to retail products. A POS application can then access information about the product. The expansion dock 204 or mobile computer device 202 can keep an inventory of the products sold using the barcode identification. A credit card reader 214 can be attached to the expansion dock 204 to access customer credit card or debit card information, or similar financial information that can be read. In some examples, the credit card reader 214 can be coupled directly with the expansion dock 204. The PnP control interface 114 of FIG. 1 can be stored by a storage device and executed by a processor in either the mobile computer device 202, or the expansion dock, or both.

The PnP control interface 114 may restore a process of the control layer after each peripheral POS device hot-plug event. For example, when the mobile computer device 202 undocks, the PnP control interface 114 will perform finalization methods to the list of peripherals in the LDN library. This logic will help clear and terminate any active threads, which may be polling for a device that no longer exists or is no longer attached to the mobile computer device 202.

When the mobile computer device 202 is docked, the PnP control interface 114 will perform initialization methods to the list of LDN in the LDN library. This logic will open new threads to initiate communications with peripherals attached to the expansion dock 204 or the POS terminal with the expansion dock 204. For additional UPOS methods, devices, and applications, the PnP control interface 114 may act as a bypass filter. Such a bypass filter can be based, for example, on a control interface that is to redirect the control calls. In some examples, a set or small library transparently intercepts application programming interface (API) calls, and communicates certain parameters to the control layer and device drivers.

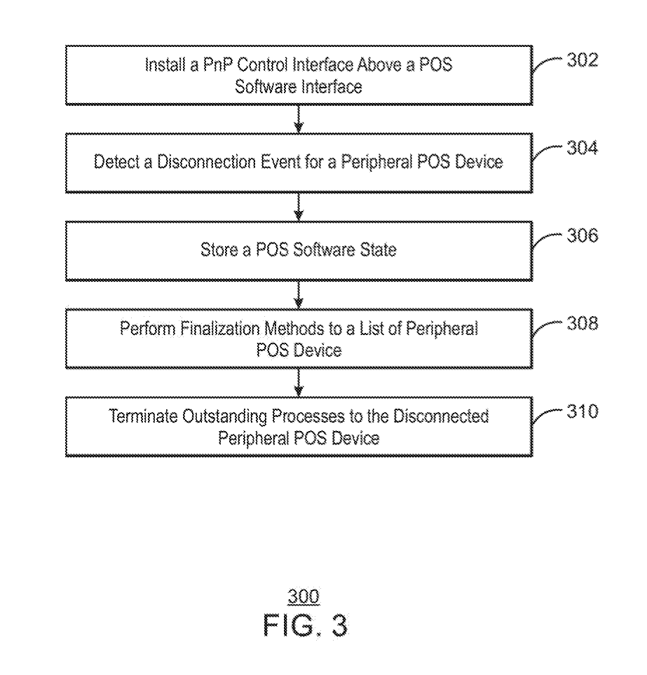

The LDN library will contain the list of devices that the PnP control interface 114 can control. The library will be extensible to include unique ID, via a device instance ID, device SN, Mac ID, or the like, to query any particular expansion dock 204. The mobile computer device 202 can be connected to a network 216, and the network can be connected to, for example, servers 218 to send or receive data and instructions. The servers 218 may provide information about products, for example, using the numbers from barcodes. The connection 220 to the network 216 from the mobile computer device 202 may be wireless to allow communications when the mobile computer device 202 is undocked. In some examples, the expansion dock 204 may couple to the network 216, for example, through a wired line 222. The mobile computer device 202 and the expansion dock 204 can implement the method described with respect to FIG. 3. In some examples, the aforementioned peripheral POS devices and applications of the computer system 200 can be implemented by, for example, a mobile computer device 202 like the ElitePad™ Mobile POS Solution by HP® in conjunction with an expansion dock 204 like the Retail Expansion Dock™ by HP®.

The block diagram of FIG. 2 is not intended to indicate that the computer device 100 is to include all of the components shown in FIG. 2. Any number of additional components may be included within the computer system 200, depending on the details of hot-plug control and specific implementation of PnP functionality for POS devices described herein. For example, additional peripheral devices can also be connected to either the mobile computer device 202 or the expansion dock 204 and provide the functionality described herein. This includes, for instance, POS devices to recognize a radio frequency ID of a particular product or device. Further, the items discussed are not limited to the functionalities mentioned, but the functions could be done in different places, or by different devices, if at all.

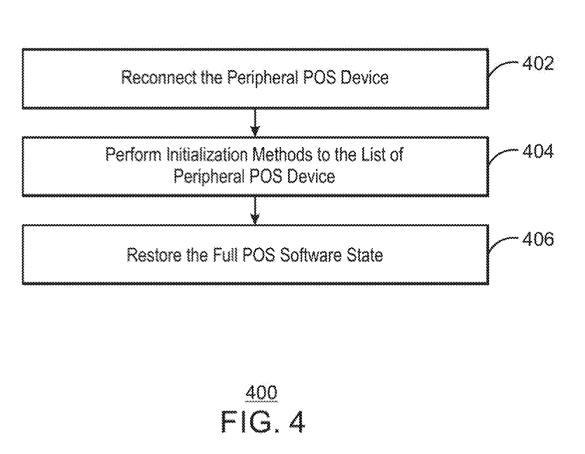

FIG. 3 is an example process flow diagram of an example method for implementing PnP support for the removal of a peripheral POS device. The method 300 can be implemented by the computer device 100 of FIG. 1, the computer system 202 of FIG. 2, and the computer-readable media 400 of FIG. 4. The method 300 begins at block 302, at which a PnP control interface is installed above a point of sale software interface, such as a POS, OPOS, or UPOS software interface. The PnP control interface is a way for UPOS compliant applications to avoid significant updates to the application while ensuring all POS peripheral drives support PnP.

At block 304, a disconnection event, such as an undocking event, is detected for a peripheral POS device. The method 300 provides a mobile POS solution to incompatibility issues with retail peripherals. An undocking event from a computer expansion dock, or the like, initiates PnP support for peripheral POS devices. The long life cycles of POS systems and peripherals rake incorporating method 300 preferable to upgrading hardware.

At block 306, a POS or UPOS software state is stored, for example, as a checkpoint in storage. A software state is saved by a computer system to oversee the control layer within an UPOS application. A hot-plug control layer is above the UPOS software interface and a particular configuration is saved.

At block 308, finalization techniques are performed to a list of active peripheral POS devices. The finalization techniques include disable, release, and close calls, for devices in a disconnected or undocked state. The call stack is updated, and drivers ensure the UPOS stack retains the point at which each active subroutine should return control when finished executing.

At block 310, outstanding processes for the disconnected peripheral POS device are terminated. Among other things, this ensures that software threads supporting the disconnected peripheral devices will not stop the system, for example, by waiting for a signal from the peripheral. The support for plug and play devices described herein is not limited to disconnecting the POS devices without causing software problems, but may be used to connect and automatically configure POS devices while powered.

FIG. 4 is a process flow diagram of an example method 400 for implementing PnP support for the connection of a peripheral POS device. In this example, it may be assumed that the PnP interface has been installed over the POS software interface, as described with respect to block 302.

At block 402, the peripheral POS device is connected to the computer device, such as the expansion dock. Then at block 404, initialization methods are performed to the list of peripheral POS devices, for example, by the PnP interface. The initialization methods may follow general UPOS practices and include an open call for initiating a thread, a claim call for coupling the thread to an active device, and an enable call for starting the device operations. For example, the initialization method may be part of the UPOS (Unified Point of Service) specification. In this specification, the open call specifies the existence of the device LDN, the claim calls gain exclusive use of the device LDN, and the enable command brings the device to operational state. The method 400 thus detects mobile POS device connection and disconnection events and performs initialization techniques upon reconnection.

At block 406, the full POS software state is restored to operate the same as before the undocking event. The method 400 is useful overcoming stability and security issues as a result of dynamic POS device removal.

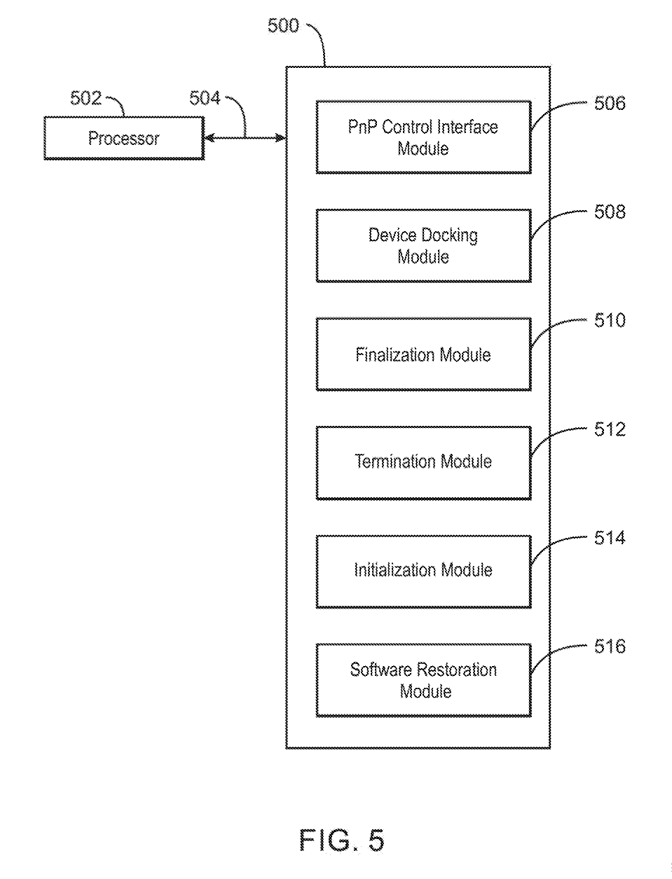

FIG. 5 is an example block diagram showing a non-transitory, computer-readable media 500 that holds code that enables PnP support for a peripheral POS device. The computer-readable media 500 can be accessed by a processor 502 over a system bus 504. In some examples, the code may direct the processor 502 to perform the steps of the current method as described with respect to FIG. 3.

The computer-readable media 500 can include a PnP control interface module 506. The PnP control interface module 506 may be act as a control interface layer between device drivers of a computer device and a UPOS software application. The computer-readable media 500 utilizes the PnP control interface module 506 as a bypass for additional UPOS calls. The PnP control interface module 506 communicates directly to a device control driver of the computer device.

The PnP control interface module 506 is to initiate event polling for a hot-dock event. The PnP control interface module 508 can trigger checking a configuration library containing a LDN and a polling ID. In some examples, the event polling is based on a unique ID, and the unique ID can include a device instance ID. In some examples, the event polling is based on a general ID, and the general ID includes a general hub controller shared by multiple computer docking stations.

The computer-readable media 500 can include a device docking module 508. The device docking module 508 identifies that a hot-dock event has occurred. The device docking module 508 can trigger determining whether the particular LDN exists and if the polling ID matches at the PnP control interface module 506. Thus, device docking module 508 can determine an ID for the physical devices that are coupled to the docking module.

The computer-readable media 500 can include a finalization module 510. The finalization module 510 is to perform finalization methods on a device listed in the LDN library upon an undocking detection. The finalization methods proceed when it is determined by the finalization module 510 the LDN exists and polling ID matches.

The computer-readable media 500 can include a termination module 512. The termination module 512 is to terminate any ongoing processes by a peripheral POS device that has been removed from the expansion dock.

The computer-readable media 500 can include an initialization module 514. The initialization module 514 is to perform initialization methods on a device listed in a LDN library upon a docking detection. The initialization methods are to proceed when it is determined by the initialization module 510 whether the LDN exists and the polling ID is a match.

The computer-readable media 500 can include a software recognition module 516. The software recognition module 516 does not require rewriting existing POS drivers or applications. The techniques herein are applicable toward any combination of legacy or PnP-enabled POS drivers. The software recognition module 516 safely restores a UPOS software state to that before the undocking event. The computer-readable media 500 ensures POS software does not require extensive updates to reattach devices when a peripheral POS device is reconnected to an expansion dock.

The block diagram of FIG. 5 is not intended to indicate that the computer-readable media 500 is to include all of the components or modules shown in FIG. 5. Further, any number of additional components may be included within the computer-readable media 500, depending on the details of hot-plug control and specific implementation of PnP functionality for POS devices described herein.

While the present techniques may be susceptible to various modifications and alternative forms, the exemplary examples discussed above have, been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method for implementing plug and play (PnP) support for a peripheral point of sale (POS) device, comprising:
installing a PnP control interface above a universal point of sale (UPOS) software interface;
detecting a disconnection of a peripheral POS device;
storing a UPOS software state for the peripheral POS device;
using the PnP control interface to perform finalization methods on a list of active peripheral POS devices in a Logical Device Name (LDN) library; and
terminating an outstanding process for the peripheral POS device.

2. The method of claim 1, comprising using the PnP control interface to perform a disable call, a release cal or a close call, or any combinations thereof.

3. The method of claim 1, comprising:
detecting a reconnection of the peripheral POS device;
using the PnP control interface to perform initialization methods on the list of active peripheral POS devices in the LDN library; and
restoring the UPOS software state to the UPOS software state before the disconnection.

4. The method of claim 3, comprising using the PnP control interface to perform an open call, a claim call, or an enable call, or any combinations thereof.

5. The method of claim 1, comprising intercepting calls for the UPOS software interface in the PnP control interface.

6. The method of claim 5, comprising passing calls from the PnP control interface to the UPOS software interface.

7. The method of claim 1 comprising communicating with the peripheral POS device through a serial connection.

8. A point of sale device, comprising:
a processor to execute instructions;
a peripheral interface for connecting a peripheral point of sale (POS) device;
and
a storage device that stores instructions, the storage device comprising a plug and play (PnP) control interface and a universal point of sale (UPOS) software interface, wherein the PnP control interface comprises code to direct the processor to:
detect a disconnection of a peripheral POS device;
retain a UPOS software state relative to the peripheral POS device;
perform finalization methods to a list of peripheral devices in a Logical Device Name (LDN) library; and
terminate an outstanding process for the peripheral POS device.

9. The point of sale device of claim 8 wherein the PnP control interface comprises code to direct the processor to:
detect a reconnection of the peripheral POS device:
perform initialization methods to the list of peripheral devices in the LDN library; and
restore the UPOS software state to the UPOS software state existing before the disconnection.

10. The point of sale device of claim 8, comprising an expansion dock to allow the docking of a portable peripheral POS device, wherein the portable peripheral POS device is disconnected by removal from the expansion dock and reconnected by insertion into the expansion dock.

11. The point of sale device of claim 10, wherein the portable peripheral POS device comprises a mobile computer device to provide product information and record purchases while disconnected.

12. The computer expansion dock of claim 10, comprising a mobile computer device that comprises a barcode scanner, a magnetic stripe, or a wireless network interface, or any combinations thereof.

13. A non-transitory, machine-readable medium, comprising instructions that when executed by a processor cause the processor to:
detect a disconnection of a peripheral point of sale (POS) device;
store a UPOS software state for the peripheral POS device;
use a PnP control interface to perform finalization methods to a list of active peripheral devices in a Logical Device Name (LDN) library; and
terminate an outstanding process to a peripheral POS device removed by the disconnection.

14. The non-transitory, machine-readable medium of claim 13, comprising instructions that when executed by a processor cause the processor to:
detect a reconnection of the peripheral POS device;
use the PnP control interface to perform initialization methods to the list of peripheral devices in the LDN library; and
restore the UPOS software state to the UPOS software state before the disconnection.

15. The non-transitory, machine-readable medium of claim 13, further comprising instructions that when executed by a processor cause the processor to:
intercept calls for a UPOS software interface;
determine if the calls should be processed in the PnP control interface; and,
if not, pass the calls on to the UPOS software interface.
